(19) United States
(12) Patent Application Publication
(10) Pub. No.: US 2012/0036967 A1
(43) Pub. Date: Feb. 16, 2012

(54) RATCHET WRENCH HAVING ROTATABLY ATTACHED SOCKETS

(76) Inventor: JUNG-CHOU HSU, Taichung City (TW)

(21) Appl. No.: 12/856,681

(22) Filed: Aug. 15, 2010

(51) Int. Cl. B25B 13/46

(52) U.S. Cl. 81/62

(57) ABSTRACT

The ratchet wrench has a head section in at least one of its two ends. An engaging member is configured in the head section and a fitting element is in turn pin-joined to the engaging member. The rotational axis of the fitting element is orthogonal to an operational axis of the engaging member. Around the fitting element, one or more sockets of various sizes perpendicular to the rotational axis of the fitting element are provided. As such, there is no need to carry a large number of removable sockets and the sockets could be switched more quickly. In the mean time, as the ratchet wrench could be turned in a reciprocating motion to tighten or loosen a bolt or nut, without removing and refitting the ratchet wrench after each turn. The ratchet wrench of the present invention strikes a successful compromise between functionality and convenience.

### (a) TECHNICAL FIELD OF THE INVENTION

The present invention generally relates to ratchet wrenches, and especially relates to a ratchet wrench whose sockets could fit on nuts or bolts of various sizes.

### (b) DESCRIPTION OF THE PRIOR ART

A ratchet wrench is a hand tool that includes a ratcheting mechanism that allows a bolt or nut to be tightened or loosened with a reciprocating motion, without requiring that the wrench be removed and refitted after each turn. A conventional ratchet wrench is shown in FIGS. 1 and 2. As illustrated, a head section 15 is formed in at least one of a wrench 10's two ends. Inside the head section 15, an engaging piece 16 and a selection rod 17 are provided where the selection rod 17 determines which direction the engaging piece 16 is turned by the wrench 10. Separate, removable sockets 20 are provided to tighten or loose many different sizes of fittings and fasteners (e.g., nuts and bolts). Each socket 20 has a pivot hole 21 for joining with the engaging piece 16, and a fitting hole 22 to fit a nut or bolt of a specific size.

For the conventional ratchet wrench described above, sockets 20 of various sizes have to be ready and changed when a different nut or bolt is encountered during usage. Not only a large number of sockets 20 have to be available and the repeated changes of sockets 20 cause operational inconvenience and delay. In addition, the pivot hole 21 and the fitting hole 22 of a conventional socket 20 is always axially aligned, which limits the design flexibility of the socket 20.

In other words, the conventional ratchet wrench is limited by its structure and, therefore, a large number of sockets have to be ready and available and repeated socket changes are inevitable. This is especially troublesome when working at heights. In reality, the nuts and bolts of the same machine or apparatus usually have similar sizes. As such, if a socket could be designed to fit on nuts or bolts of different sizes, this would definitely enhance operational speed and convenience.

### SUMMARY OF THE INVENTION

A major objective of the present invention is to provide a ratchet wrench having rotatably attached sockets that could fit on nuts or bolts of various sizes so as to enhance operational convenience.

To apply the ratchet wrench on bolts or nuts of different sizes, the attached sockets could be turned along an axis to select one matching the bolt or nut. As such, there is no need to carry a large number of removable sockets as in the prior arts and the sockets could be switched more quickly. In the mean time, as the ratchet wrench could be turned in a reciprocating motion to tighten or loosen the bolt or nut, without removing and refitting the ratchet wrench after each turn. The ratchet wrench of the present invention strikes a successful compromise between functionality and convenience. The ratchet wrench therefore enjoys a higher add-on value and economical benefit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a conventional ratchet wrench is joined with a socket.

FIG. 2 is a sectional diagram showing the conventional ratchet wrench and socket of FIG. 1.

FIG. 3 is a perspective diagram showing a ratchet wrench according to an embodiment of the present invention.

FIG. 4 is a perspective break-down diagram showing the various components of the ratchet wrench of FIG. 3.

FIG. 5 is a schematic side-view diagram showing the ratchet wrench of FIG. 3.

FIG. 6 is a schematic top-view diagram showing the ratchet wrench of FIG. 3 is configured to operate in one direction.

FIG. 7 is a schematic top-view diagram showing the ratchet wrench of FIG. 3 is configured to operate in another direction.

FIG. 8 is a schematic side-view diagram showing a ratchet wrench according an alternative embodiment of the present invention.

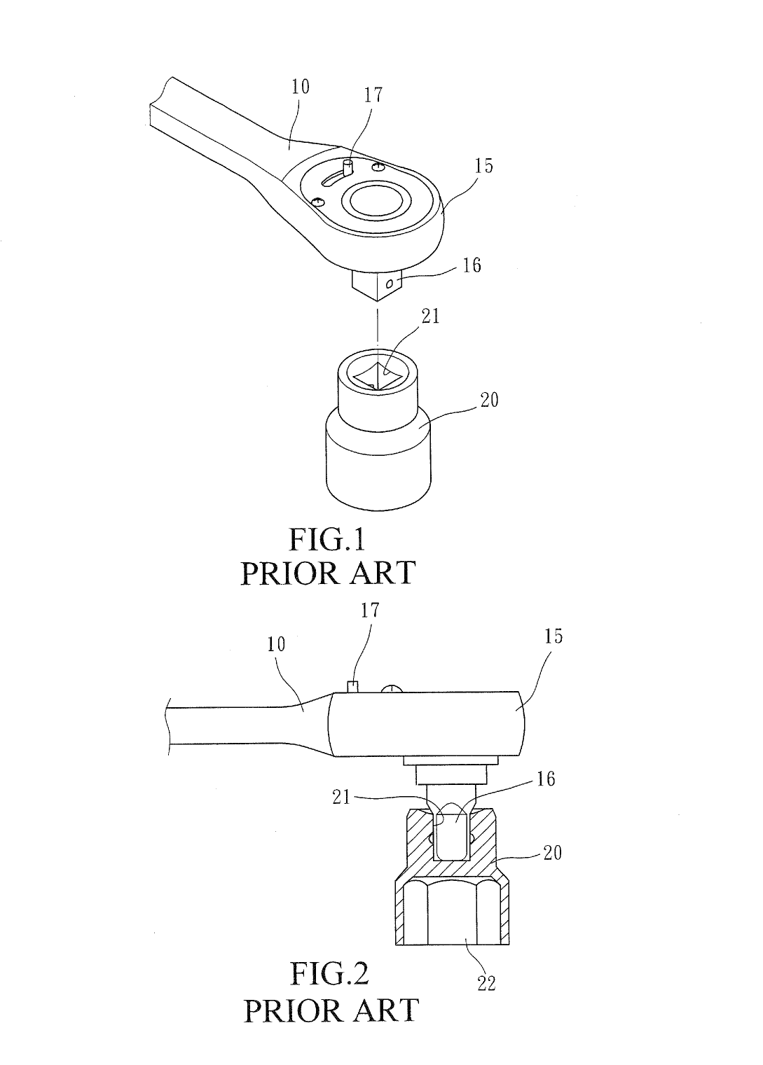

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

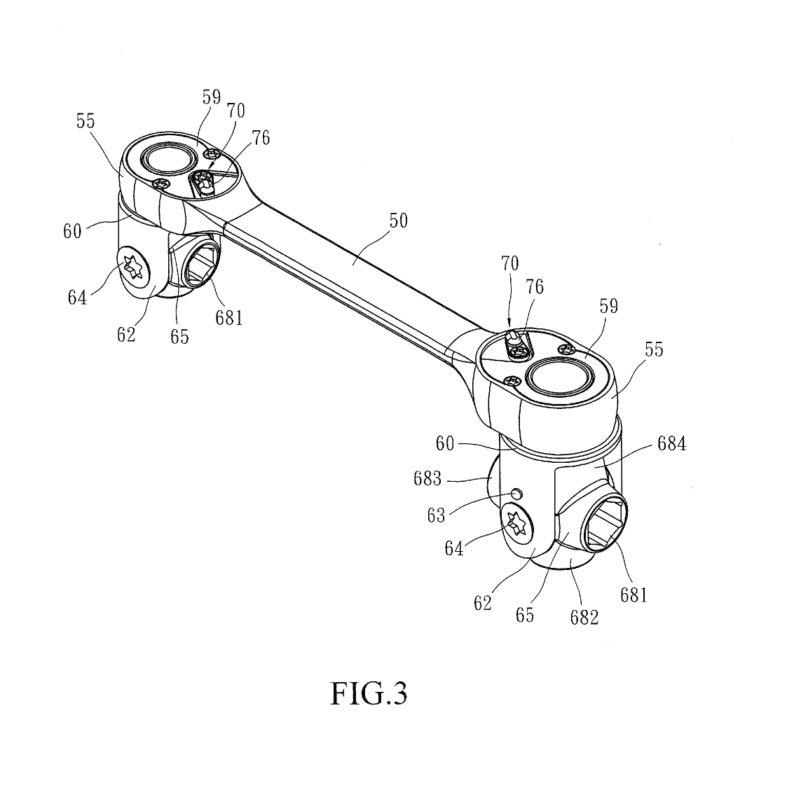

As illustrated in FIG. 3, a ratchet wrench in accordance with an embodiment of the present invention contains a wrench 50, and a head section 55 formed in at least one of the wrench 50's two ends. In the present embodiment, each end of the wrench 50 is configured with a head section 55. Inside the head section 55, an engaging member 60 is provided. In the present embodiment, the two engaging members 60 are configured to the same side of the wrench 50 while, in an alternative embodiment shown in FIG. 8, the two engaging members 60 are configured to opposite sides of the wrench 50. Each engaging member 60 has a pin-joined fitting element 65 with multiple fitting holes. For each head section 55, a selection mechanism 70 is provided on a side opposite to the engaging member 60. The selection mechanism determines which direction the engaging member 60 is turned by the wrench 50.

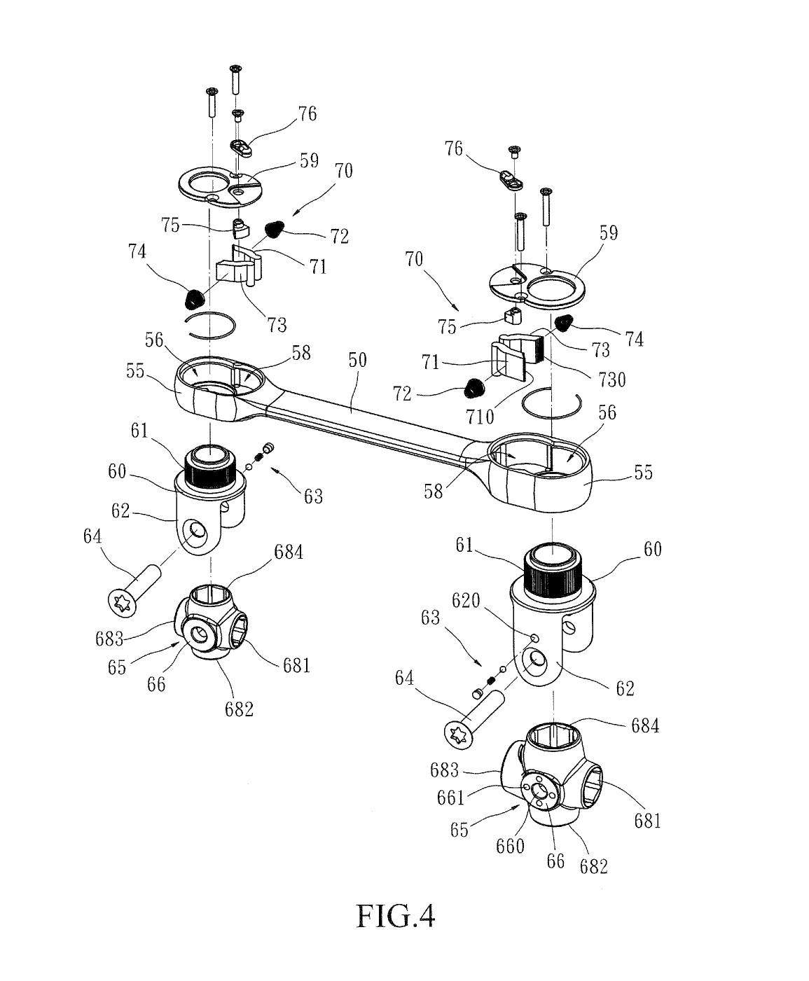

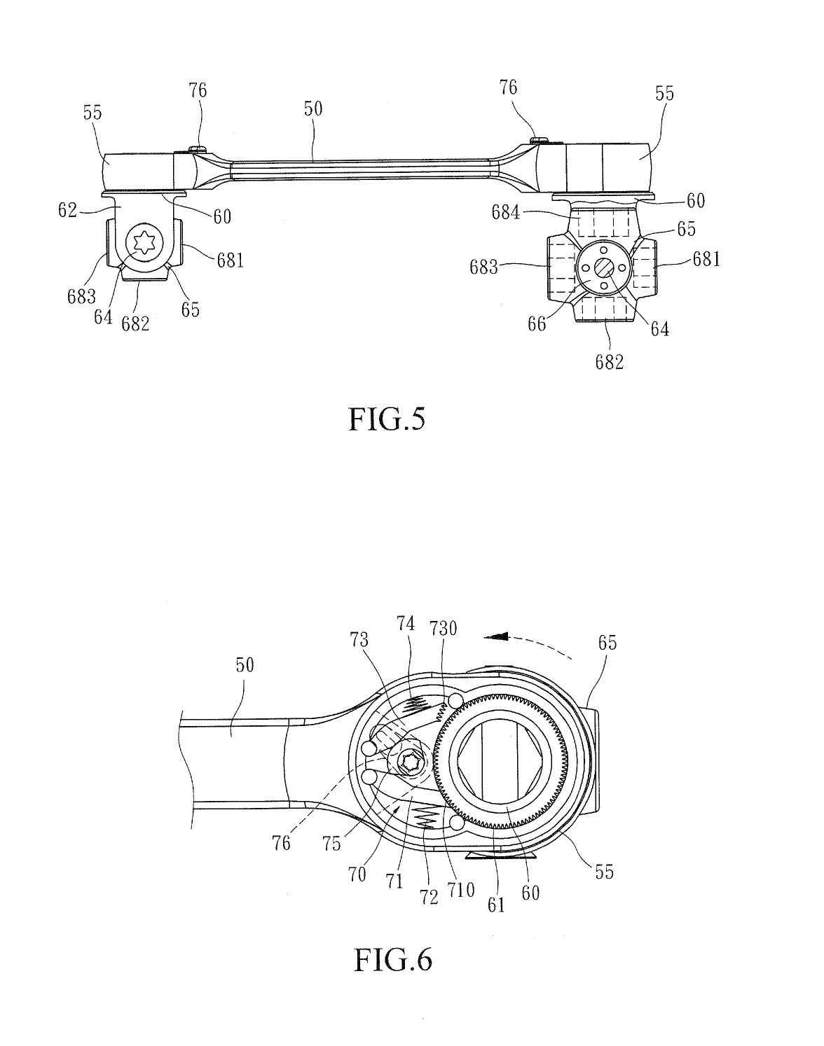

As further shown in FIGS. 4 and 5, within each head section 55 of the wrench 50, there are a through wheel chamber 56 and an open configuration chamber 58 laterally connected together. The wheel chamber 56 is to accommodate a gear wheel 61 of the engaging member 60. The configuration chamber 58 is to accommodate the selection mechanism 70. A cover piece 59 is used to seal an open side of the wheel chamber 56 and the configuration chamber 58.

The gear wheel 61 is configured at an end of each engaging member 60. Two opposing and parallel ear pieces 62 are extended from the other end of the engaging member 60 for pin-joining the fitting element 65. On a first ear piece 62, a bolt hole 620 is provided for a limiting element 63 to thread through. The limiting element 63, from inside out, contains a steal ball, a spring, and a stopping bolt, so that the steal ball provides an elastic latching to the fitting element 65 through the bolt hole 620. The fitting element 65 is positioned between the ear pieces 62 and is rotatably joined with the engaging member 60 by threading a pin 64 through the ear pieces 62 and a through axle hole 660 in a central axial section 66 of the fitting element 65. The rotational axis of the fitting element 65 and the operational axis of the engaging member 60 are as such orthogonal. On the axial section 66, a number of limiting indentations 661 are configured around the axle hole 660 for engaging the steal ball of limiting element 63. A number of sockets are configured around the circumference of the fitting element 65, and perpendicular to the rotational axis of the fitting element 65. In the present embodiment, four sockets of different sizes, namely, a first socket 681, a second socket 682, a third socket 683, a fourth socket 684, are provided to fit on bolts or nuts of four different sizes.

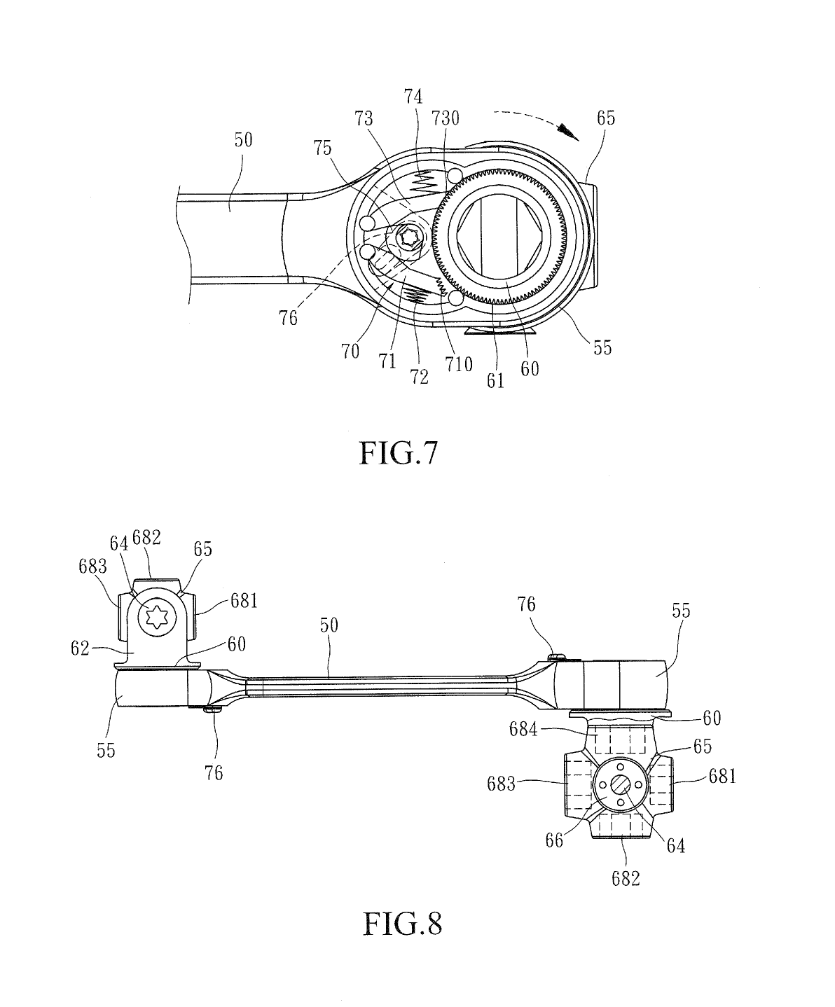

The selection mechanism 70 contains two arm pieces 71 and 73 inside the configuration chamber 58. The arm pieces 71 and 73 have a pivotal end and a free end. The pivotal ends are adjacent with each while the free ends are extended in a C-like shape towards two separate spots along the rim of the gear wheel 61 (as illustrated in FIGS. 6 and 7). Teeth 710 and 730 are configured on inner sides of the free ends of arm pieces 71 and 73 interfacing with the gear wheel 61, respectively. On the other hands, two elastic elements 72 and 74 are configured between the wall of the configuration chamber 58 and outer sides (opposite to the inner sides where teeth 710 and 730 are configured) of the arm pieces 71 and 73's free ends, respectively. The two elastic elements 72 and 74 push the free ends (and therefore their teeth 710 and 730) to swing around the pivotal ends and to engage the gear wheel 61. A selection block 75 is configured inside the configuration chamber 58 and between the arm pieces 71 and 73. The selection block 75 is engaged by a selection switch 76 on the cover piece 59 which, in one of the selection switch 76's two configurations, the arm pieces 71 or 73 are selectively pushed away from the gear wheel 61.

As described above, a ratchet wretch compromising functionality (capable of operating various bolts or nuts) and convenience (no need to carry multiple sockets) are achieved.

The operation of the ratchet wretch is depicted in FIGS. 3, 5, 6, and 7. As illustrated, to tighten or loose a bolt or nut, the selection switch 76 is set to a specific configuration where one of the arm pieces 71 and 73 is pushed away from the gear wheel 61 while the other arm piece 73 or 71 engages the gear wheel 61 by the corresponding elastic element 730 or 710. As such, the wretch 50 (and therefore the engaging member 60) could be turned in a reciprocating motion to tighten or loosen a bolt or nut, without removing and refitting the ratchet wrench after each turn.

To apply the ratchet wretch on a bolt or nut, as shown in FIGS. 3 and 5, the fitting element 65 is rotated relatively to the engaging member 60 until one of the first, second, third, and fourth sockets 681, 682, 683, 684 that matches the bolt or nut faces is properly oriented downward. When the fitting element 65 is adjusted as described, the limiting element 63 locks into one of the limiting indentations 661 on the axial section 66 so that, during the ratchet wretch's operation, the fitting element 65 is confined and does not rotate arbitrarily. In the mean time, the first, second, third, and fourth sockets 681, 682, 683, 684 could be conveniently and quickly switched.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A ratchet wrench, comprising:
a wrench with two ends, a head section being configured in at least an end, an open configuration chamber and a through wheel chamber laterally connected together inside said head section;
a selection mechanism in said configuration chamber for setting an operational direction of said ratchet wrench;
an engaging member having a gear wheel in said wheel chamber and two ear pieces extended downward; and
a fitting element pin-joined to said ear pieces of said engaging member so that said fitting element has a rotational axis orthogonal to an operational axis of said wrench, said fitting element having a plurality of sockets of different sizes around said fitting element's circumference.

2. The ratchet wrench according to claim 1, further comprising a cover piece sealing an open side of said configuration chamber and said wheel chamber.

3. The ratchet wrench according to claim 1, wherein said fitting element has a central axial section with an axle hole; and a pin threads through said axle hole and said ear pieces to pin-join said fitting element to said engaging member.

4. The ratchet wrench according to claim 1, wherein a bolt hole is provided on a first ear piece through which a limiting element having, from inside out, a steal ball, a spring, and a stopping bolt is threaded; a plurality of limiting indentation are configured on said axial section of said fitting element around said axle hole; and said steal ball is locked into one of said limiting indentation to confine said fitting element from arbitrary rotation.

5. The ratchet wrench according to claim 1, wherein said selection mechanism contains two arm pieces, two elastic elements; a selection switch, and a selection block; said arm pieces are configured inside said configuration chamber; each arm piece has a pivotal end and a free end; said pivotal ends are adjacent with each other while said free ends are extended in a C-like shape towards two separate spots along the rim of said gear wheel; teeth are configured on an inner side of each arm piece; an elastic element is configured between the wall of said configuration chamber and an outer side of each free end so as to push said teeth to engage said gear wheel; said selection block is configured inside said configuration chamber and between said arm pieces; and said selection block is engaged by said selection switch in one of two configurations to selectively push one of said arm pieces away from said gear wheel.

6. The ratchet wrench according to claim 1, further comprising a second head section in the other end; and a second engaging member in said second head section.

7. The ratchet wrench according to claim 6, wherein said engaging member and said second engaging member are on a same side of said wrench.

8. The ratchet wrench according to claim 6, wherein said engaging member and said second engaging member are on different sides of said wrench.

9. The ratchet wrench according to claim 3, wherein a bolt hole is provided on a first ear piece through which a limiting element having, from inside out, a steal ball, a spring, and a stopping bolt is threaded; a plurality of limiting indentation are configured on said axial section of said fitting element around said axle hole; and said steal ball is locked into one of said limiting indentation to confine said fitting element from arbitrary rotation.
